(19) United States
(12) Patent Application Publication
(10) Pub. No.: US 2006/0017012 A1
(43) Pub. Date: Jan. 26, 2006

(54) Ion implantation apparatus

(76) Inventor: Takatoshi Yamashita, Minami-ku (JP)

Correspondence Address: HARNESS, DICKEY & PIERCE, P.L.C., P.O. BOX 8910, RESTON, VA, 20195, US

(21) Appl. No.: 11/167,189

(22) Filed: Jun. 28, 2005

(30) Foreign Application Priority Data
Jul. 20, 2004 (JP) 2004-212161

(51) Int. Cl. G21G 5/00

(52) U.S. Cl. 250/492.1

(57) ABSTRACT

An ion source capable of generating only a monoatomic ion is used as an ion source, and a gas supplying section is provided between a first mass spectrograph and a second mass spectrograph. In order to irradiate a cluster molecule ion, a polyatomic molecule gas is introduced into the gas supplying section. Then, electric charges are exchanged between the monoatomic ion generated at the ion source and a polyatomic molecule gas introduced into the gas supplying section, so that the cluster molecule ion is generated. Thus, the cluster molecule ion is dissociated at the second mass spectrograph. In order to irradiate a monoatomic ion beam, a monoatomic ion generated at the ion source is irradiated without introducing a gas into the gas supplying section.

This Nonprovisional application claims priority under 35 U.S.C. § 119(a) on Patent Application No. 2004/212161 filed in Japan on Jul. 20, 2004, the entire contents of which are hereby incorporated by reference.

### FIELD OF THE INVENTION

The present invention relates to an ion implantation apparatus which irradiates ions having kinetic energy toward a sample. More particularly, the present invention relates to an ion implantation apparatus which facilitates not only irradiation of normal ions (B, P, As) but also irradiation of B₁₀H₁₄ gas cluster molecule ions.

### BACKGROUND OF THE INVENTION

In a manufacturing process of a semiconductor apparatus such as a transistor or the like, impurities are doped in a semiconductor layer made of silicon or the like in order to form a source drain region of the transistor. Conventionally, in order to dope impurities into the semiconductor layer, ion implantation apparatuses have been widely used.

First, as a general structure of a conventional ion implantation apparatus, the following description explains an ion implantation apparatus described in Japanese Laid-Open Patent Publication No. 105901/1995 (Tokukaihei 7-105901, publication date: Apr. 21, 1995) with reference to FIG. 2.

The ion implantation apparatus illustrated in FIG. 2 includes an ion source 1 for generating an ion beam, a first mass spectrograph 2 for spectroscoping a mass of the ion beam into desired impurity ions, and an accelerator 3 for accelerating the ion beam.

In the subsequent stage of the accelerator 3, a second mass spectrograph 5 having a filter magnet 4 is provided. Further, in the traveling direction of the ion beam passing through the second mass spectrograph 5, a monitor faraday 6 is provided in this order.

Like the first mass spectrograph 2, the second mass spectrograph 5 having the filter magnet 4 generates a magnetic field, thereby deflecting the ion beam. Also, the intensity of the magnetic field can be adjusted so that only a desired ion beam passes through an outlet of the second mass spectrograph 5. The monitor faraday 6 detects a beam current of the ion beam emitted through the accelerator 3 from the first mass spectrograph 2, so as to check the ion beam deflected by the first mass spectrograph 2 travels on a regular path.

In the traveling direction of the ion beam deflected by the second mass spectrograph 5, a horizontal scanner 7 is provided. Thus, the ion beam passing through the horizontal scanner 7 is scanned in the horizontal direction due to actions of the horizontal scanner 7.

In the traveling direction of the ion beam passing through the horizontal scanner 7, a collimation magnet 8 is provided. The collimation magnet 8 deflects the ion beam scanned by the horizontal scanner 7 in the direction of a wafer 9.

The wafer 9 receiving the ion beam from the collimation magnet 8 is provided at an end station 10, and is moved up and down by a clump mechanism (not shown). The up and down driving and the horizontal scanning of the ion beam are carried out simultaneously, so that ions can be implanted to a target sample evenly.

As described above, a main object of the ion implantation apparatus is to implant impurities into the semiconductor layer by irradiating impurities into a semiconductor layer made of silicon or the like in the manufacturing process of the semiconductor apparatus. Ions implanted in the process of manufacturing the semiconductor are usually monoatomic ions such as B⁺, B⁺⁺, P⁺, P⁺⁺, P⁺⁺⁺, As⁺, As⁺⁺, and the like.

In order to implant a large quantity of ions with low energy, cluster ions utilizing a gas such as B₁₀H₁₄ or the like is useful. However, a gas of this type is easily dissociated and contaminated.

As illustrated in FIG. 3, U.S. Pat. No. 6,545,419 discloses an ion source having a double-tank structure made up of a plasma generating tank 21 and a charge exchanging tank 22. The plasma generating tank 21 causes thermal electrons emitted from a filament 23 provided in the magnetic field to ionize a gas introduced from a gas conduit 24 into the plasma generating tank 21. In this manner, monoatomic ions are generated in the plasma generating tank 21. This is based on the following reason: Due to high temperature inside the plasma generating tank 21, polyatomic molecules are dissociated, so that cluster molecule ions cannot be generated stably. Note that, the structure of the plasma generating tank 21 is commonly used as an ion source in a general ion implantation apparatus capable of irradiating monoatomic ions.

Monoatomic ions generated in the plasma generating tank 21 are sent to the charge exchanging tank 22 through an opening 25. In the charge exchanging tank 22, a polyatomic molecule gas, which is a source of cluster molecule ions (for example), is introduced through the gas conduit 26. The monoatomic ions are neutralized through the charge exchange in the charge exchanging tank 22. Thus, the polyatomic molecule gas in the charge exchanging tank 22 is ionized, so as to become cluster molecule ions.

The cluster molecule ions generated in the charge exchanging tank 22 are drawn to the outside of the ion source by an electric field of a drawing electrode (not shown) provided at the exterior of an opening 27. Further, when the ion source disclosed in the U.S. Pat. No. 6,545,419 is used as the ion source 1 disclosed in Tokukaihei 7-105901, an ion implantation apparatus irradiating cluster molecule ions can be realized.

Further, in an ion implantation apparatus utilizing the ion source described in U.S. Pat. No. 6,545,419, when a polyatomic molecule gas is not introduced into the charge exchanging tank 22 (that is, the charge exchange does not occur) and monoatomic ions generated in the plasma generating tank 21 are directly drawn to the outside, monoatomic ions can be irradiated.

### SUMMARY OF THE INVENTION

An object of the present invention is to provide an ion implantation apparatus capable of irradiating both monoatomic ions and cluster molecule ions without dropping an efficiency at which ions are utilized.

In the present invention, in order to achieve the foregoing object, the ion implantation apparatus which generates an ion and irradiates a generated ion as ion beam includes at least: an ion source generating a monoatomic ion; a first mass spectrograph provided at a downstream of the ion source; a gas supplying section provided at a downstream of the first mass spectrograph which allows a gas to be introduced therein; and a second mass spectrograph provided at a downstream of the gas supplying section.

In order to irradiate cluster molecule ions, the ion implantation apparatus is operated while a polyatomic molecule gas is introduced in the gas supplying section. In this case, monoatomic ions generated at the ion source and dissociated from other ions at the first mass spectrograph are made to exchange the charges with the polyatomic molecules at the gas supplying section, so that cluster molecule ions are generated. The generated cluster molecule ions are dissociated from other ions at the second mass spectrograph, so as to be irradiated as an ion beam.

On the other hand, in order to irradiate monoatomic ions, the ion implantation apparatus is operated without introducing a gas into the gas supplying section. In this case, monoatomic ions generated at the ion source and dissociated from other ions at the first mass spectrograph are irradiated as an ion beam.

According to the arrangement, cluster molecule ions are not generated at the ion source but at the gas supplying section provided away from the ion source with the first mass spectrograph therebetween. Thus, in the ion implantation apparatus capable of irradiating both monoatomic ions and cluster molecule ions, an efficiency at which monoatomic ions are drawn from the ion source will not be dropped unlike the conventional arrangement generating both monoatomic ions and cluster molecule ions at the ion source.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a diagram illustrating a structure of important parts of an ion implantation apparatus according to one embodiment of the present invention.

FIG. 2 is a diagram illustrating a structure of important parts of a conventional ion implantation apparatus.

FIG. 3 is a cross-sectional view illustrating a conventional ion source capable of generating cluster molecule ions.

### DESCRIPTION OF THE EMBODIMENTS

### First Embodiment

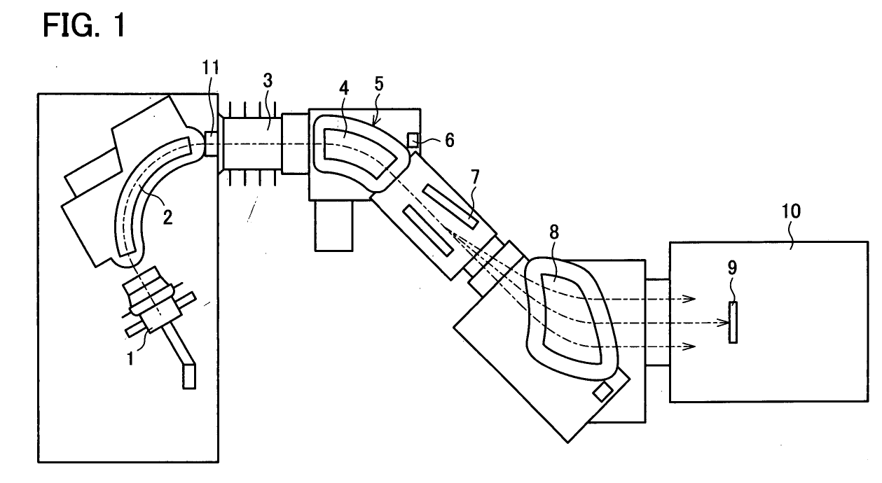

With reference to FIG. 1, one embodiment of the present invention is described below. First, a structure of an ion implantation apparatus of the present embodiment is illustrated in FIG. 1.

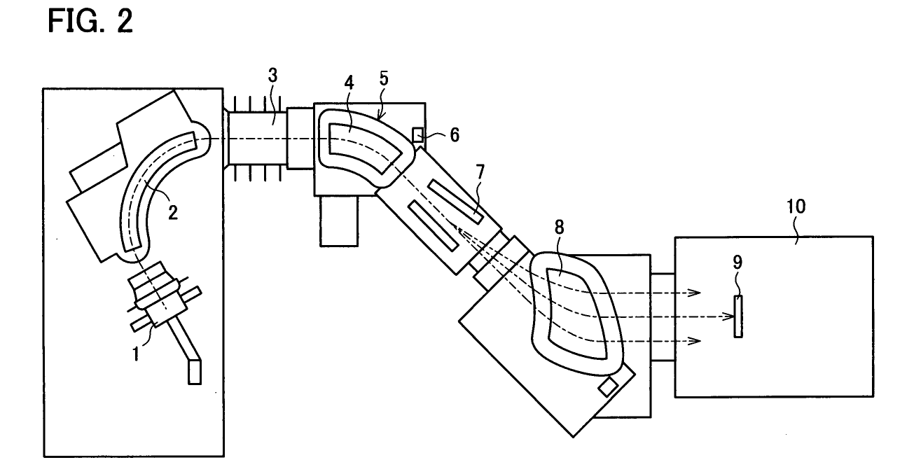

The ion implantation apparatus illustrated in FIG. 1 has a structure similar to that of an ion implantation apparatus illustrated in FIG. 2. Thus, the same numbers are given to parts having the same structures and functions, and detailed explanations thereof are omitted.

The ion implantation apparatus of the present embodiment differs from the conventional structure in that a gas supplying section 11 is provided between a first mass spectrograph 2 and an accelerator 3. A gas conduit (not shown) allows a gas to be introduced into the gas supplying section 11.

In order to irradiate monoatomic ions, the ion implantation apparatus is operated without introducing a gas into the gas supplying section 11. An ion source 1 is a normal ion source (ion source capable of generating only monoatomic ions) consisting merely of a plasma generating tank. Thus, monoatomic ions generated from the ion source 1 can be drawn efficiently. That is, in irradiating monoatomic ions, the ion implantation apparatus performs ion irradiation in the same manner as the conventional ion implantation apparatus.

On the other hand, in order to irradiate cluster molecule ions, the ion implantation apparatus is operated under such a condition that a polyatomic molecule gas is introduced into the gas supplying section 11. In this case, when the monoatomic ions generated at the ion source 1 (e.g., Ar⁺) pass through the first mass spectrograph 2 and reach the gas supplying section 11, the charges are exchanged at the gas supplying section 11. Thus, cluster molecule ions are generated.

The cluster molecule ions generated at the gas supplying section 11 have no kinetic energy when generated. Therefore, the cluster molecule ions need to be drawn to the ion irradiation side. In the ion implantation apparatus illustrated in FIG. 1, the accelerator 3 draws the cluster molecule ions generated at the gas supplying section 11. That is, the accelerator 3 has a multistage structure including an electric conductor and an insulator, so as to provide predetermined kinetic energy to ions passing through the inner portion with an acceleration voltage generated at the accelerator 3. However, the acceleration voltage is used also to draw cluster molecule ions from the gas supplying section 11. According to the arrangement, in the ion implantation apparatus, it is possible to omit the drawing electrode that draws cluster molecule ions from the gas supplying section 11. Further, the accelerator 3 can function as a decelerator.

The cluster molecule ions drawn from the gas supplying section 11 are irradiated in a manner similar to irradiation of monoatomic ions.

As described above, in the ion implantation apparatus of the present embodiment, cluster molecule ions are not generated at the ion source 1 for irradiation. Instead, in the subsequent stage of the ion source 1, the gas supplying section 11 is provided for generating cluster molecule ions through the charge exchange.

In the structure of FIG. 1, the gas supplying section 11 is provided between the first mass spectrograph 2 and the accelerator 3. However, in the ion implantation apparatus of the present invention, the position of the gas supplying section 11 is not limited to this.

In the ion implantation apparatus of the present invention, a gas supplying section is placed in the subsequent stage of a first mass spectrograph that dissociates desired ions from ions generated at an ion source (normally, unnecessary ions as well as desired ions are generated at the ion source). That is, with reference to the structure of FIG. 1, the gas supplying section 11 is placed in the subsequent stage of the first mass spectrograph 2.

In this manner, the gas supplying section 11 is placed in the subsequent stage of the first mass spectrograph 2, so that the first mass spectrograph 2 is provided between the ion source 1 and the gas supplying section 11. Therefore, heat generated at the ion source 1 is not easily transmitted to the gas supplying section 11. Accordingly, a polyatomic molecule gas introduced to the gas supplying section 11 is prevented from being dissociated by heart. Thus, cluster molecule ions can be generated more stably.

When using a polyatomic molecule gas introduced into the gas supplying section 11 with a gas showing strong reactions with other gases, a problem occurs. However, the problem can be prevented in a following manner.

For generating cluster molecule ions, a polyatomic molecule gas such as B₁₀H₁₄ (decaborane) can be used. On the other hand, B⁺ is one of the monoatomic ions commonly used in the semiconductor manufacturing process. In order to generate B+, BF₃ is normally used at the ion source 1.

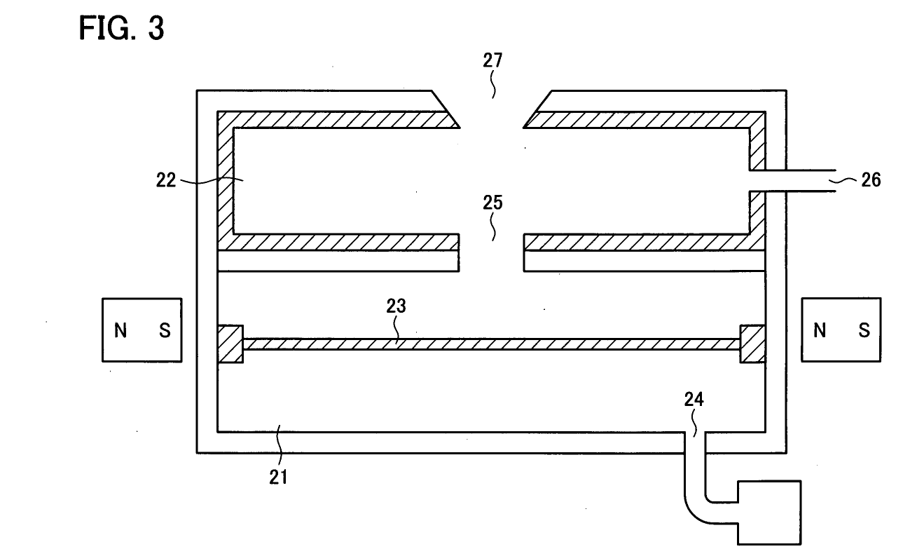

Assume that B₁₀H₁₄ is used to generate cluster molecule ions (B₁₀H₁₄⁺) with the ion source having the structure of FIG. 3, and then BF₃ is used to generate B⁺. In this case, when B⁺ is generated, B₁₀H₁₄ in the charge exchanging tank 22 is exhausted. However, it is difficult to completely exhaust B₁₀H₁₄ due to the structure of the ion source, and some B₁₀H₁₄ remains as a residual gas. Also, as to BF₃ introduced in the plasma generating tank 21 for generating B⁺, BF₃ can be kept from entering into the charge exchanging tank 22. Therefore, inside the ion source having the structure of FIG. 3, a reaction occurs between B₁₀H₁₄ and BF₃, so that fluorine occurs. Fluorine is a highly corrosive acid, and has a significant damaging effect on the life of the ion source.

On the contrary, in the ion implantation apparatus of the present embodiment, the damaging effect can be avoided, even when operation for generating cluster molecule ions (B₁₀H₁₄⁺) using B₁₀H₁₄ and operation for generating B⁺ using BF₃ are carried consecutively. The gas supplying section 11 where B₁₀H₁₄ is introduced and the ion source 1 where BF₃ is introduced are placed away from each other with the first mass spectrograph 2 therebetween. Thus, the gases rarely mix and react.

In the ion implantation apparatus of the present invention, a gas supplying section is provided in the preceding stage of a second mass spectrograph. That is, with reference to the structure of FIG. 1, the gas supplying section 11 is placed in the preceding stage of the second mass spectrograph 5. The following is the reason.

That is, the gas supplying section 11 causes monoatomic ions passing through the first mass spectrograph 2 to hit polyatomic molecules in the gas supplying section 11, thereby exchanging the charges and generating cluster molecule ions. However, the ions generated here are not only desired cluster molecule ions. Therefore, in the ion implantation apparatus, the second mass spectrograph 5 is provided in the subsequent stage of the gas supplying section 11, so that only desired cluster molecule ions can be dissociated.

Further, as to the positions of the gas supplying section 11 and the accelerator 3, it is preferable to place the gas supplying section 11 in the preceding stage of the accelerator 3 as illustrated in FIG. 1. That is, as described above, the gas supplying section 11 is placed in the preceding stage of the accelerator 3, so that an acceleration voltage of the accelerator 3 can be utilized to draw cluster molecule ions from the gas supplying section 11. Thus, the structure of the ion implantation apparatus can be simplified, while the accelerator 3 can control kinetic energy of irradiated cluster molecule ions accurately.

However, the present invention is not limited to this, and the gas supplying section 11 may be placed in the subsequent stage of the accelerator 3. In this case, a drawing electrode is required in drawing cluster molecule ions from the gas supplying section 11. Also, kinetic energy of the irradiated cluster molecule ions can be controlled with the drawing electric field at the drawing electrode as well.

As described above, the ion implantation apparatus of the present invention, which generates an ion and irradiates a generated ion as ion beam includes at least an ion source for generating a monoatomic ion; a first mass spectrograph provided at a downstream of the ion source; a gas supplying section, provided at a downstream of the first mass spectrograph, which allows a gas to be introduced therein; and a second mass spectrograph provided at a downstream of the gas supplying section.

In order to irradiate cluster molecule ions, the ion implantation apparatus is operated while a polyatomic molecule gas is introduced in the gas supplying section. In this case, monoatomic ions generated at the ion source and dissociated from other ions at the first mass spectrograph are made to exchange the charges with polyatomic molecules at the gas supplying section, so that cluster molecule ions are generated. The generated cluster molecule ions are dissociated from other ions at the second mass spectrograph, so as to be irradiated as an ion beam.

On the other hand, in order to irradiate monoatomic ions, the ion implantation apparatus is operated while a gas is not introduced into the gas supplying section. In this case, monoatomic ions generated at the ion source and dissociated from other ions at the first mass spectrograph are irradiated as an ion beam.

According to the arrangement, cluster molecule ions are not generated at the ion source, but at the gas supplying section provided away from the ion source through the first mass spectrograph. Thus, in the ion implantation apparatus capable of irradiating both monoatomic ions and cluster molecule ions, an efficiency at which monoatomic ions are drawn from the ion source will not be dropped unlike the conventional arrangement generating both monoatomic ions and cluster molecule ions at the ion source.

In the ion implantation apparatus, it is also preferable that an accelerating and decelerating device is provided between the gas supplying section and the second mass spectrograph.

According to the arrangement, an acceleration voltage generated at the accelerating and decelerating device can be utilized to draw cluster molecule ions generated at the gas supplying section. Therefore, a drawing electrode for drawing cluster molecule ions from the gas supplying section can be omitted from the ion implantation apparatus.

The invention being thus described, it will be obvious that the same way may be varied in many ways. Such variations are not to be regarded as a departure from the spirit and scope of the invention.

What is claimed is:

1. An ion implantation apparatus, which generates an ion and irradiates a generated ion as ion beam, comprising at least:
an ion source for generating a monoatomic ion;
a first mass spectrograph provided at a downstream of the ion source;
a gas supplying section, provided at a downstream of the first mass spectrograph, which allows a gas to be introduced therein; and
a second mass spectrograph provided at a downstream of the gas supplying section.

2. The ion implantation apparatus according to claim 1, wherein
an accelerating and decelerating conduit is provided between the gas supplying section and the second mass spectrograph.
